(19) United States
(12) Patent Application Publication
(10) Pub. No.: US 2010/0264799 A1
(43) Pub. Date: Oct. 21, 2010

(54) LED LAMP

(75) Inventors: TAY-JIAN LIU, Tu-Cheng (TW); NA ZHANG, Shenzhen City (CN); FENG TIAN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/540,332

(22) Filed: Aug. 12, 2009

(30) Foreign Application Priority Data
Apr. 20, 2009 (CN) 200910301672.5

(51) Int. Cl. H01J 61/52

(52) U.S. Cl. 313/46; 362/294

(57) ABSTRACT

An LED lamp includes a hollow lamp housing, a front optical part, a rear electrical part provided with a circuit board, and a middle heat dissipation part. The heat dissipation part includes a heat sink, and a mounting seat located in front of and thermally connected to the heat sink. The lamp housing defines a plurality of air exchanging holes therein. The mounting seat is in the form of a polyhedron, and has a polyhedral rear end surface and a plurality of heat absorbing surface. The optical part includes a plurality of light sources respectively arranged on the heat absorbing surfaces, a light reflector located between the heat sink and the light sources, and an optical lens located in front of the light reflector. The heat absorbing surfaces extend forwardly from a peripheral edge of the rear end surface towards the optical lens and facing the optical lens.

### BACKGROUND

1. Technical Field

The present disclosure relates to light emitting diode (LED) lamps, and particularly to an LED lamp with a high heat dissipating efficiency, a large illumination area and an even illumination intensity.

2. Description of Related Art

In recent years, LEDs are preferred for use in LED lamps rather than CCFLs (cold cathode fluorescent lamps) and other traditional lamps due to their excellent properties, including high brightness, long lifespan, directivity, and etc.

For an LED, about eighty percents of the power consumed thereby is converted into heat. Generally, an LED lamp includes a plurality of LEDs arranged on a flat surface. Therefore, a heat dissipation device is necessary for timely and adequately removing the heat generated by the LEDs. In addition, since the LEDs are arranged in a flat surface, an illumination area of the LEDs is limited. Thus, the LED lamp cannot obtain a desired illumination area.

For the foregoing reasons, therefore, there is a need in the art for an LED lamp which overcomes the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a cross-sectional view of an LED lamp in accordance with a first embodiment.

FIG. 2 is an assembled, isometric view of a light engine of the LED lamp of FIG. 1.

FIG. 3 is an assembled, isometric view of a mounting seat of the light engine of FIG. 2 according to a second embodiment with a plurality of light sources mounted thereon.

FIG. 4 is an assembled, isometric view of a mounting seat according to a third embodiment with a plurality of light sources mounted thereon.

FIG. 5 is an assembled, isometric view of a mounting seat according to a fourth embodiment with a plurality of light sources mounted thereon.

FIG. 6 is a cross-sectional view of an LED lamp in accordance with a second embodiment.

FIG. 7 is an assembled, isometric view of a light engine of the LED lamp of FIG. 6.

FIG. 8 is an assembled, isometric view of an alternative light engine.

FIG. 9 is a cross-sectional view of an LED lamp in accordance with a third embodiment.

### DETAILED DESCRIPTION

Reference will now be made to the drawing figures to describe the various embodiments in detail.

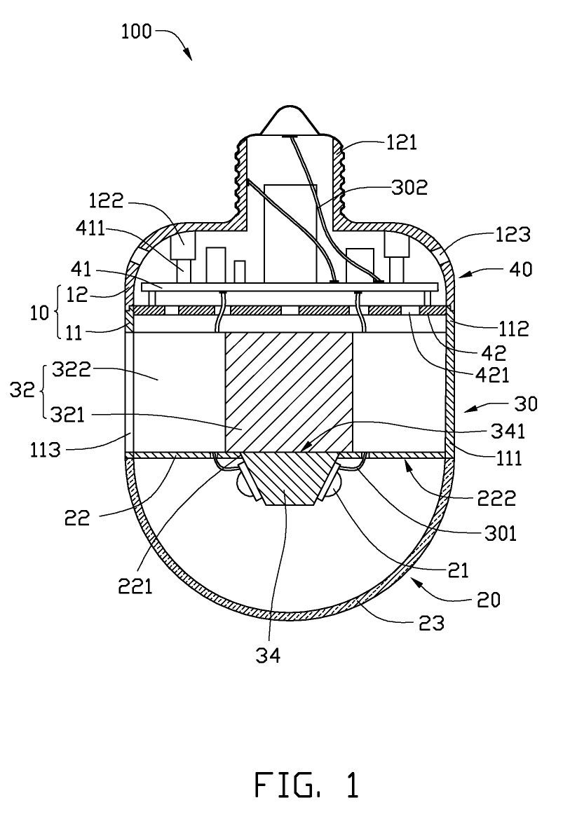

Referring to FIG. 1, an LED lamp 100 according to a first embodiment includes a hollow lamp housing 10, an optical part 20, a heat dissipation part 30, and an electrical part 40. The LED lamp 100 is substantially cylindrical. The optical part 20 is arranged at a front end of the LED lamp 100. The electrical part 40 is arranged at a rear end of the LED lamp 100. The heat dissipation part 30 is located between the optical part 20 and the electrical part 40. The heat dissipation part 30 and the electrical part 40 are received in the lamp housing 10.

The lamp housing 10 includes a front shell 11 and a rear shell 12 connected to the front shell 11. The front shell 11 is a hollow cylinder, and has a front end 111 and an opposite rear end 112. The heat dissipation part 30 is arranged in the front shell 11, while the electrical part 40 is arranged in the rear shell 12. The rear shell 12 is cup-shaped. The rear shell 12 has an open front end connected with the rear end 112 of the front shell 11, and a rear screwed lamp holder 121 for electrically connecting with a power socket.

The heat dissipation part 30 is provided with a heat sink 32 arranged in the front shell 11 and a mounting seat 34 arranged in front of the heat sink 32.

The heat sink 32 is made of a material having a high heat conductivity, such as aluminum or aluminum alloy. The heat sink 32 includes a column-shaped solid base 321 and a plurality of fins 322 extending radially and outwardly from a circumferential surface of the solid base 321. The front shell 11 defines a plurality of air exchanging holes 113 therein, located corresponding to the fins 322 of the heat sink 32, to thereby allow an ambient airflow to flow into and out of the front shell 11. The air exchanging holes 113 are longitudinally extended in a circumferential surface of the front shell 11, and are defined radially through the circumferential surface of the front shell 11.

The mounting seat 34 is located in front of the heat sink 32 and directly thermally connected to a front end of the heat sink 32 which faces the optical part 20. Alternatively, the mounting seat 34 can be thermally connected to the heat sink 32 via a heat conducting member with high heat transfer efficiency such as a heat pipe. The mounting seat 34 is made of a material having a high heat conductivity, such as copper or copper alloy, and has a configuration of a frustum of a pyramid.

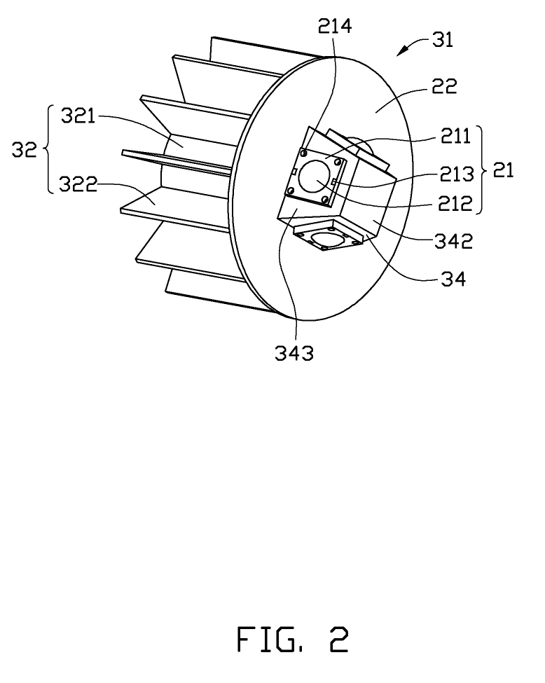

Referring also to FIG. 2, in this embodiment, the mounting seat 34 is in the form of a frustum of a square pyramid. The mounting seat 34 includes a square rear end surface 341 attached to the heat sink 32, an opposite square front end surface 342 parallel to the rear end surface 341, and four sloping heat absorbing surfaces 343 between the rear end surface 341 and the front end surface 342. Each heat absorbing surface 343 extends from the rear end surface 341 to the front end surface 342 and converges towards a tip of the square pyramid. A cross-sectional area of the mounting seat 34 is gradually decreased from the rear end surface 341 towards the front end surface 342 of the mounting seat 34. The rear end surface 341 of the mounting seat 34 is connected to a front end of the solid base 321 of the heat sink 32. The mounting seat 34 and the heat sink 32 are separately made to simplify the manufacturing process. Alternatively, the mounting seat 34 and the heat sink 32 can be integrally formed as a monolithic piece so as to reduce a thermal resistance therebetween.

The optical part 20 is arranged in front of the heat dissipation part 30. The optical part 20 includes a plurality of light sources 21 mounted on the heat absorbing surfaces 343 of the mounting seat 34, a light reflector 22 and an optical lens 23. Each of the light sources 21 includes a substrate 211, a pair of electrodes 213 formed on the substrate 211, and at least one LED 212 (light emitting diode) arranged on the substrate 211 and electrically connected to the electrodes 213. The light sources 21 are respectively mounted on the heat absorbing surfaces 343 of the mounting seat 34, to thereby obtain a three-dimensional illumination coverage. The light sources 21, the mounting seat 34 and the heat sink 32 cooperatively form a light engine 31 for the LED lamp 100.

A plurality of through holes 214 are defined in the substrate 211 of each light source 21 and located adjacent to a peripheral edge of the substrate 211. Fixing devices, such as screws, extend through the through holes 214 of the substrate 211 of each light source 21 and threadedly engage into a corresponding heat absorbing surface 343 of the mounting seat 34, to thereby securely attach the light source 21 to the corresponding heat absorbing surface 343 of the mounting seat 34.

When the light sources 21 are mounted to the heat absorbing surfaces 343 of the mounting seat 34, a layer of thermal interface material (TIM) may be applied between the substrate 211 of each light source 21 and the corresponding heat absorbing surface 343 of the mounting seat 34 to eliminate an air interstice therebetween, to thereby enhance a heat conduction efficiency between the light source 21 and the mounting seat 34. Alternatively, the substrate 211 of each light source 21 can be attached to the corresponding heat absorbing surface 343 of the mounting seat 34 fixedly and intimately through surface mount technology (SMT).

The light reflector 22 is located between the heat sink 32 and the light sources 21, and surrounds the mounting seat 34, to thereby optically isolate the light sources 21 from the heat sink 32. The light reflector 22 is round plate-shaped, and defines a positioning hole 221 therein for the mounting seat 34 extending therethrough. The light reflector 22 forms a planar light reflecting surface 222 at a front side thereof facing the light sources 21. Light beams emitted by the light sources 21 are evenly reflected by the light reflector 22 to the optical lens 23.

The optical lens 23 is located in front of the light reflector 22 and mounted to the front end 111 of the front shell 11. The optical lens 23 has a configuration of a hollow hemisphere. The light reflector 22 and the optical lens 23 cooperatively receive the mounting seat 34 and the light sources 21 therein. The light sources 21 mounted on the heat absorbing surfaces 343 of the mounting seat 34 face the optical lens 23. Light emitted by the light sources 21 radiate radially towards the optical lens 23 in every direction. The optical lens 23 can form a plurality of spherical protrusions thereon to expand the illumination area of the LED lamp 100 and reduce glare from the light sources 21.

The electrical part 40 provides drive power, control circuit and power management for the light sources 21. The electrical part 40 includes a circuit board 41 received in an inner space of the rear shell 12. The circuit board 41 electrically connects with the electrodes 213 of the light sources 21 via a plurality of electrical wires 301 and electrically connects with the screwed lamp holder 121 via a plurality of electrical wires 302, whereby the LED lamp 100 can get power from an external power source via the power socket (not shown) connected to the screwed lamp holder 121. The circuit board 41 is mounted in the rear shell 12 via a plurality of sockets 122 and a plurality of connecting poles 411. The sockets 122 are attached to an inner surface of the rear shell 12. The connecting poles 411 connect the circuit board 41 with the sockets 122. The heat dissipation part 30 further includes a partition plate 42 arranged between the circuit board 41 and the heat sink 32. The partition plate 42 is mounted to the rear end 112 of the front shell 11 and defines therein a plurality of air openings 421 which communicate the heat dissipation part 30 with the electrical part 40. A plurality of air apertures 123 are defined radially through the rear shell 12 at a position adjacent to the screwed lamp holder 121. The air apertures 123 communicate the inner space of the rear shell 12 with an outside environment, and are utilized for dissipating heat generated by the circuit board 41.

In operation, heat generated by the LEDs 212 of the light sources 21 is absorbed by the mounting seat 34 and rapidly transferred to the solid base 321 and the fins 322 of the heat sink 32. Air in passages defined between adjacent fins 322 of the heat sink 32 is heated by the heat transferred to the fins 322 and the solid base 321, and then floats upwardly. One portion of the heated, upwardly floating air escapes to the ambient atmosphere via the air exchanging holes 113 of the front shell 11. The other portion of the heated, upwardly floating air enters into the rear shell 12 via the air openings 421 of the partition plate 42, and then escapes to the ambient atmosphere via the air apertures 123 of the rear shell 12. Cooling air in the ambient atmosphere enters into the front shell 11 via the air exchanging holes 113 of the front shell 11, whereby a natural air convection is circulated through the front shell 11 and the rear shell 12 of the lamp housing 10. Thus, the heat of the LEDs 212 of the light sources 21 is continuously and effectively removed.

In the LED lamp 100, the mounting seat 34 is in the form of a polyhedron (i.e., a frustum of a square pyramid), and has a polyhedral rear end surface 341 facing the heat sink 32 and a plurality of sloping heat absorbing surfaces 343. The light sources 21 are mounted on the sloping heat absorbing surfaces 343 of the mounting seat 34. An angle between the rear end surface 341 and each of the absorbing surfaces 343 is less than 90 degrees. Alternatively, the mounting seat 34 can have a configuration of other polyhedron, such as a pyramid or a prism.

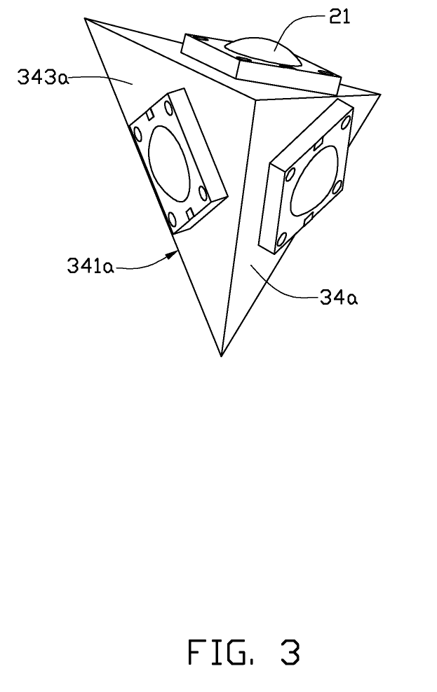

FIG. 3 shows an alternative mounting seat 34a with a plurality of light sources 21 mounted thereon. In the present embodiment, the mounting seat 34a has a configuration of a triangular pyramid. The mounting seat 34a includes a triangular rear end surface 341a facing the heat sink 32, and three sloping heat absorbing surfaces 343a extending from a peripheral edge of the rear end surface 341a towards the optical lens 23 and converging at a tip of the triangular pyramid. The light sources 21 are mounted on the heat absorbing surfaces 343a of the mounting seat 34a, respectively.

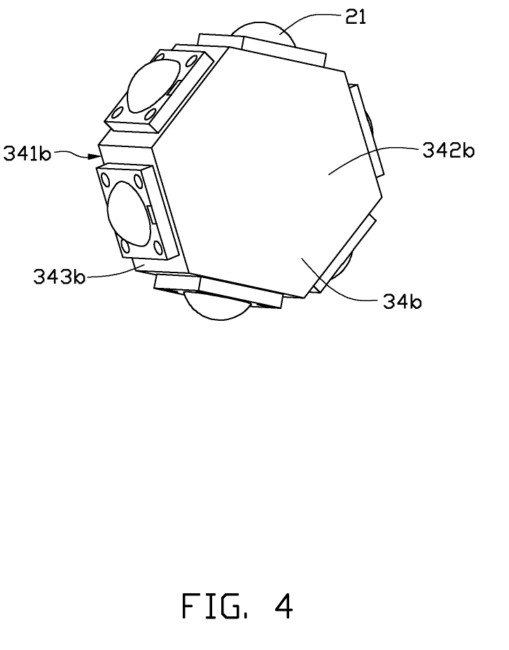

FIG. 4 shows a further alternative mounting seat 34b with a plurality of light sources mounted thereon. In the present embodiment, the mounting seat 34b has a configuration of a hexagonal prism. The mounting seat 34b includes a hexagonal rear end surface 341b facing the heat sink 32, an opposite hexagonal front end surface 342b parallel to the rear end surface 341b, and six heat absorbing surfaces 343b between the rear end surface 341b and the front end surface 342b and perpendicular to the front and rear end surfaces 341b, 342b. The light sources 21 are mounted on the heat absorbing surfaces 343b of the mounting seat 34b, respectively. An angle between the rear end surface 341b and each absorbing surface 343b is 90 degrees.

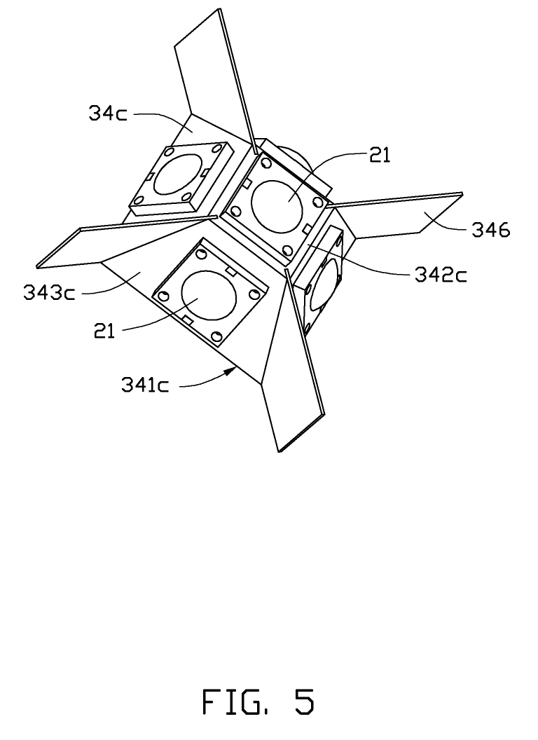

FIG. 5 shows another further alternative mounting seat 34c with a plurality of light sources 21 mounted thereon. In the present embodiment, the mounting seat 34c is in the form of a frustum of a square pyramid. The mounting seat 34c includes a square rear end surface 341c facing the heat sink 32, an opposite square front end surface 342c parallel to the rear end surface 341c, and four heat absorbing surfaces 343c between the rear end surface 341c and the front end surface 342c. The heat absorbing surfaces 343 extend from the rear end surface 341c to the front end surface 342c and converge towards a tip of the square pyramid. Each of the heat absorbing surfaces 343c of the mounting seat 34c is attached with one light source 21. The front end surface 342c of the mounting seat 34c is further attached with a light source 21 to increase a brightness of the LED lamp. The mounting seat 34c forms a reflecting plate 346 between two adjacent light sources 21 which are mounted on two corresponding adjacent heat absorbing surfaces 343c thereof, to thereby prevent light emitted by a light source 21 from mixing with light emitted by an adjacent light source 21. The reflecting plate 346 also reflects the light emitted by the light sources 21 towards the optical lens 33. The reflecting plate 346 is connected to a joint of the two adjacent heat absorbing surfaces 343c of the mounting seat 34c. Alternatively, the mounting seats 34a, 34b of the previous embodiments shown in FIGS. 3-4 can form a reflecting plate between two adjacent light sources 21 which are mounted on two adjacent heat absorbing surfaces 343a, 343b thereof.

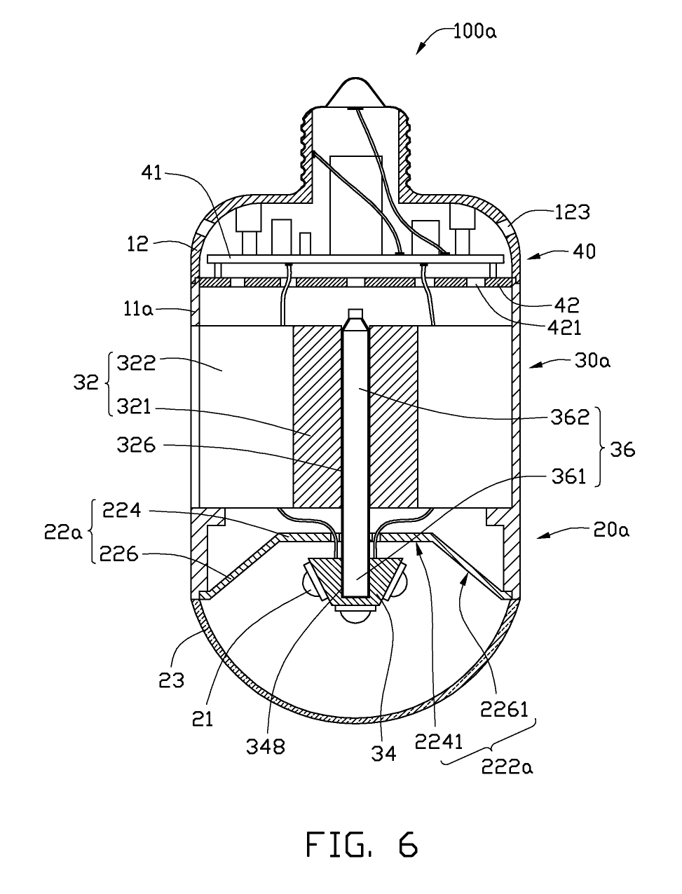

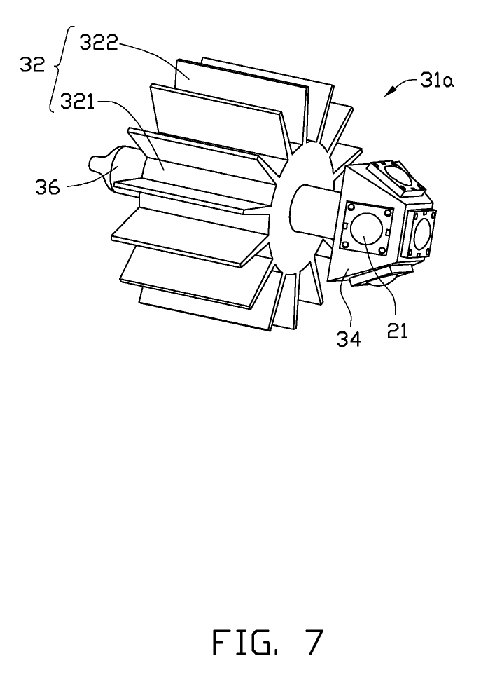

Referring to FIGS. 6-7, an LED lamp 100a according to a second embodiment is illustrated. The difference between the present LED lamp 100a and the LED lamp 100 illustrated in FIG. 1 lies in the heat dissipation part 30a and the optical part 20a. In the present embodiment, the heat dissipation part 30a further includes a heat pipe 36 connecting the mounting seat 34 with the heat sink 32, and a light reflector 22a of the optical part 20a has a configuration of a dishware. The light sources 21, the mounting seat 34, the heat pipe 36 and the heat sink 32 cooperatively form a light engine 31a for the LED lamp 100a.

It is well known in the art that a heat pipe is a sealed hollow pipe body receiving working fluid therein and containing a wick structure disposed on an inner wall of the pipe body. The heat pipe 36 transfers heat under phase change of working fluid hermetically contained therein. The heat pipe 36 is elongated and includes a front evaporating section 361 connecting with the mounting seat 34 and a rear condensing section 362 connecting with the heat sink 32. The heat sink 32 defines axially a first receiving hole 326 in the solid base 321 thereof. The condensing section 362 of the heat pipe 36 is received in the first receiving hole 326 of the heat sink 32. The mounting seat 34 defines axially a second receiving hole 348 therein. The evaporating section 361 is received in the second receiving hole 348 of the mounting seat 34. The evaporating section 361 forms a planar end surface at a free end thereof to increase a heat contacting area between the mounting seat 34 and the evaporating section 361 of the heat pipe 36.

The light reflector 22a is located between the heat sink 32 and the mounting seat 34, and surrounds the evaporating section 361 of the heat pipe 36. The light reflector 22a includes a planar mounting portion 224 and a tapered reflecting portion 226 extending forwardly and outwardly from an outer peripheral edge of the mounting portion 224 towards the optical lens 23. The light reflector 22a forms a light reflecting surface 222a at a front side thereof facing and surrounding the mounting seat 34. The light reflecting surface 222a of the light reflector 22a includes an annular planar surface 2241 formed on an inner, front side of the mounting portion 224 and a tapered surface 2261 formed on an inner, front side of the reflecting portion 226.

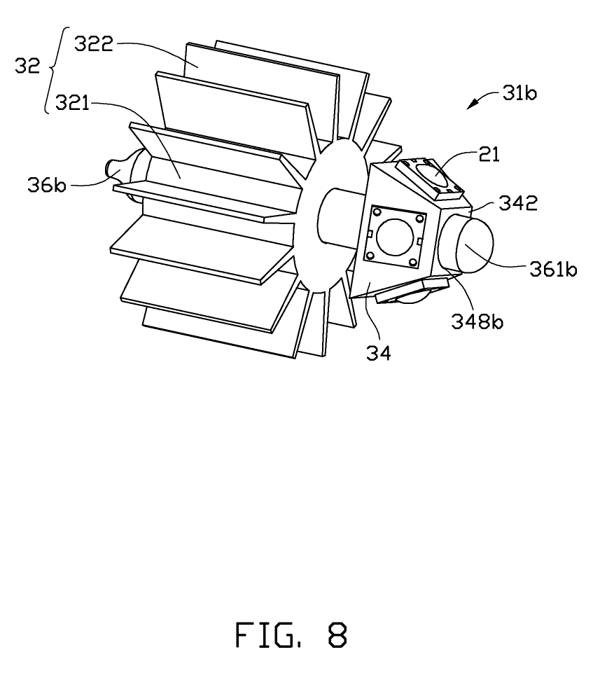

FIG. 8 shows an alternative light engine 31b which can replaces the light engine 31a of the LED lamp 100a of FIG. 6. In this embodiment, a second receiving hole 348b axially defined in the mounting seat 34 extends through two opposite ends thereof. An evaporating section 361b of a heat pipe 36b is inserted in the second receiving hole 348b and a free end of the evaporating section 361b extends forwardly beyond the front end surface 342 of the mounting seat 34. Thus the free end of the evaporating section 361b of the heat pipe 36b does not need to be formed with a planar end surface, to thereby simplify the manufacturing process and reduce the manufacturing cost of the heat pipe 36b.

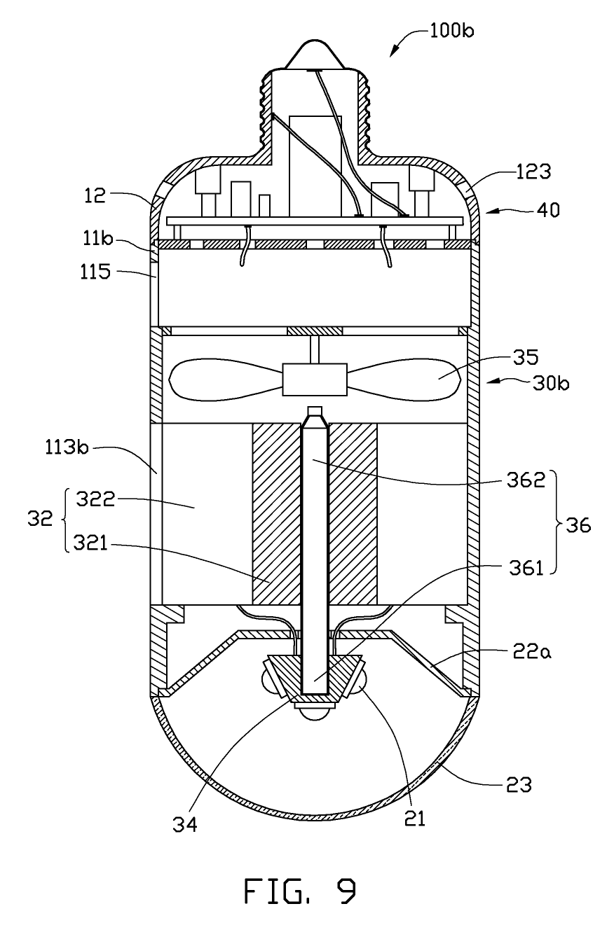

Referring to FIG. 9, an LED lamp 100b according to a third embodiment is illustrated. The difference between the present LED lamp 100b and the LED lamp 100a illustrated in FIG. 6 lies in the heat dissipation part 30b. In the present embodiment, the heat dissipation part 30b further includes a cooling fan 35 provided between the electrical part 40 and the heat sink 32.

The cooling fan 35 is located at a rear side of the heat sink 32. The front shell 11b defines radially a plurality of air exchanging holes 133b corresponding to the fins 322 of the heat sink 32 and a plurality of air openings 115 in a rear end thereof adjacent to the rear shell 12. The air openings 115 of the front shell 11 function as air supply openings or air exhausting openings for the cooling fan 35. When the cooling fan 35 operates, the cooling fan 35 inhales air from the ambient atmosphere via the air openings 115 defined in the rear end of the front shell 11. An airflow generated by the cooling fan 35 flows towards the heat sink 32, and then is exhausted out of the front shell 11 via the air exchanging holes 113b of the front shell 11 located corresponding to the fins 322 of the heat sink 32, whereby a forced air convection is circulated through the front shell 11 to further increase the heat dissipation efficiency of the LED lamp 100.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp, comprising:
a hollow lamp housing;
an optical part located at a front end of the lamp housing, the optical part comprising a plurality of light sources each being provided with at least one LED, a light reflector and an optical lens;
an electrical part located at a rear end of the lamp housing, the electrical part being provided with a circuit board electrically connecting with the light sources; and
a heat dissipation part located between the optical part and the electrical part, the heat dissipation part comprising:
a heat sink arranged in the lamp housing and comprising a plurality of fins, the lamp housing defining a plurality of air exchanging holes therein corresponding to the fins of the heat sink; and
a mounting seat located in front of the heat sink and thermally connected to the heat sink, the mounting seat being in the form of a polyhedron, the mounting seat having a polyhedral rear end surface facing the heat sink and a plurality of heat absorbing surfaces extending from the rear end surface, the light sources being respectively arranged on and thermally connected with the heat absorbing surfaces, heat generated by the light sources being absorbed by the mounting seat and then transferred to the heat sink for dissipation, the light reflector of the optical part being located between the heat sink and the light sources and optically isolating the light sources from the heat sink, the light reflector forming a light reflecting surface at a front side thereof facing the light sources, the optical lens being located in front of the light reflector and the mounting seat, the light reflector and the optical lens cooperatively receiving the mounting seat and the light sources therein, the heat absorbing surfaces extending forwardly from a peripheral edge of the rear end surface of the mounting seat towards the optical lens and facing the optical lens.

2. The LED lamp of claim 1, wherein the mounting seat has a configuration of a frustum of a pyramid and further comprises a front end surface facing the optical lens, each of the heat absorbing surfaces extending slantingly from the rear end surface to the front end surface, a cross-sectional area of the mounting seat being gradually decreased from the rear end surface to the front end surface of the mounting seat.

3. The LED lamp of claim 2, wherein the optical part further comprises a light source attached on the front end surface of the mounting seat.

4. The LED lamp of claim 1, wherein the mounting seat has a configuration of a pyramid, the heat absorbing surfaces being sloping and converging at a point.

5. The LED lamp of claim 1, wherein the mounting seat has a configuration of a prism and further comprises a front end surface facing the optical lens, each of heat absorbing surfaces extending from the rear end surface to the front end surface and perpendicular to the front and rear end surfaces.

6. The LED lamp of claim 1, wherein an angle between the rear end surface and each of the absorbing surfaces is not greater than 90 degrees.

7. The LED lamp of claim 1, wherein an angle between the rear end surface and each of the absorbing surfaces is less than 90 degrees.

8. The LED lamp of claim 1, wherein the mounting seat forms a reflecting plate between two adjacent light sources which are mounted on two corresponding adjacent heat absorbing surfaces thereof.

9. The LED lamp of claim 8, wherein the reflecting plate is connected to a joint of the two corresponding adjacent heat absorbing surfaces of the mounting seat.

10. The LED lamp of claim 1, wherein the heat sink further comprises a solid base, the fins of the heat sink extending radially and outwardly from a circumferential surface of the solid base, the heat connecting member being connected to the solid base of the heat sink.

11. The LED lamp of claim 10, wherein the mount seat is directly attached to the solid base of the heat sink, the light reflector being plate-shaped and surrounding the mounting seat.

12. The LED lamp of claim 1, wherein the heat dissipation part further comprises a heat pipe connecting the mounting seat with the heat sink, the heat pipe comprising a front evaporating section inserted in the mounting seat and a rear condensing section inserted in the heat sink.

13. The LED lamp of claim 12, wherein the heat sink further comprises a solid base, the fins of the heat sink extending radially and outwardly from a circumferential surface of the solid base, the rear condensing section of the heat pipe being inserted in the solid base of the heat sink.

14. The LED lamp of claim 12, wherein a free end of the evaporating section of the heat pipe extends forwardly beyond a front end of the mounting seat.

15. The LED lamp of claim 12, wherein the light reflector has a configuration of a dishware and comprises a planar mounting portion surrounding the evaporating section of the heat pipe and a tapered reflecting portion extending forwardly and outwardly from an outer peripheral edge of the mounting portion towards the optical lens.

16. The LED lamp of claim 1, wherein the heat dissipation part further comprises a cooling fan provided between the electrical part and the heat sink, the lamp housing further defining radially a plurality of air openings in a rear end thereof adjacent to the electrical part, the air openings functioning as air passage openings for the cooling fan.

17. The LED lamp of claim 1, wherein the lamp housing comprises a front shell and a rear shell connected to a rear end of the front shell, the optical part being arranged in front of the front shell, the heat dissipation part being arranged in the front shell, the electrical part being arranged in the rear shell.

18. The LED lamp of claim 17, wherein the front shell is a hollow cylinder and the rear shell is cup-shaped, a plurality of air apertures being defined radially through the rear shell for airflow flowing into and out of the rear shell.

19. The LED lamp of claim 17, wherein the heat dissipation part further comprises a partition plate arranged between the circuit board and the heat sink, the partition plate defining therein a plurality of air openings which communicate the heat dissipation part with the electrical part.
